(19) United States
(12) Patent Application Publication
(10) Pub. No.: US 2002/0178562 A1
(43) Pub. Date: Dec. 5, 2002

(54) Method of manufacturing a vacuum chamber

(76) Inventors: Shigeyuki Aoki, Hyogo-ken (JP); Takahiro Ogawa, Hyogo-ken (JP); Tomoyasu Minawa, Yokohama-shi (JP)

Correspondence Address: RATNERPRESTIA, P.O. BOX 1596, WILMINGTON, DE, 19889, US

(21) Appl. No.: 10/163,222

(22) Filed: Jun. 5, 2002

(30) Foreign Application Priority Data
Jun. 5, 2001 (JP) 2001-169259

(51) Int. Cl. B23P 17/00

(52) U.S. Cl. 29/412

(57) ABSTRACT

A method of manufacturing a vacuum chamber comprises the steps of: preparing a first plate material to be a wall portion of the vacuum chamber more than twice a height of a wall portion of the vacuum chamber, forming joints at side portions of the first plate material, welding the joints together by electron beam welding to form a tubular wall, and dividing the tubular wall by cutting into a plurality of tubular wall parts. The tubular wall part is connected with a second material to be a bottom portion of the vacuum chamber.

### BACKGROUND OF THE INVENTION

1. Field of the Invention

The present invention relates to a method of manufacturing a vacuum chamber which can assure high or ultra-high vacuum circumstances inside of it.

2. Description of the Related Art

The vacuum chambers are used in the process of producing electronic devices, such as semiconductors and liquid crystal displays (LCD) placed under high or ultra-high vacuum circumstances. To obtain high or ultra-high vacuum circumstances, the vacuum chamber is made of material with practically naught of outgassing from material or absorbing gas on its surface, for example, aluminum, aluminum alloy, or stainless steel. The vacuum chamber is generally shaped in a box comprising a wall portion having upper and lower edges and formed in a tubular shape, a bottom portion integrally connected with the lower edge of the wall portion, and a top-cover portionecured to the upper edge of the wall portion and covering an upper opening of the wall portion.

A conventional method of manufacturing a vacuum chamber of this kind uses tungsten inert gas (TIG) welding to weld a plurality of stainless steel plates for a wall portion and a bottom plate for a bottom portion of the vacuum chamber together to be joined each other. This method, however, encounters such a problem that a welded zone of the vacuum chamber by TIG welding generates and grows up welding layer of oxides to radiate a large quantity of gas from the welding layer, and causes large welding distortion to the vacuum chamber. Moreover this method does not meet a tendency that vacuum chambers are expected to assure higher vacuum circumstances that is needed for micro fabrication technology to produce a larger scale integration device and others. These disadvantages are the same as conventional welding.

To overcome the above problem, another conventional method of manufacturing a vacuum chamber is employed to prepare a large cuboid solid mass of aluminum or aluminum alloy and then to form a bottomed opening on it by machining operation such as milling, or milling and boring. This method utilizing the machining operation prevails in these days because this vacuum chamber avoids gas leak, outgassing from the vacuum chamber, and welding distortion because of having no welded zone. This known conventional method, however, encounters such problems that it takes a lot of time for the machining operation and that this machining operation discharges much volume of chips and shavings of aluminum or aluminum alloy out of the cuboid solid mass more than a finished vacuum chamber itself, which does not meet a tendency that vacuum chambers are expected to be larger in size, especially wide and length (The height of vacuum chambers is kept almost the same.), for producing larger LCDs and other large electronic devices. The machining operation results in that the wider and longer vacuum chambers become, the more volume of chips and saving is discharged, causing a lot of loss of material and time. In addition, this method has a restriction to obtain a large sized vacuum chamber because a large cuboid mass of aluminum or aluminum alloy is hard to be produced and costs very high.

Another conventional method of manufacturing a vacuum chamber is disclosed in Japanese patent laying-open publication Tokkaihei 11-285857. This conventional method includes a first step of preparing two wall parts formed by an extrusion process, and a second step of welding the wall parts by electron beam welding join them together and form a tubular wall. Although electron beam welding is superior to arc welding and tungsten inert gas welding in the view of outgassing from welded zones and welding distortion in high or ultra-high vacuum circumstances, it takes a very long time to make arrangements for setting of the wall parts with jigs to locate them accurately and adjusting the electron beam welding device to focus its beam on joints of the wall parts with accuracy, which results in increasing manufacturing costs. Accordingly, this conventional method is not suitable for mass production of vacuum chambers, because the above-mentioned arrangements are needed in each case to produce a single vacuum chamber.

It is, therefore, an object of the present invention to provide a method of manufacturing a vacuum chamber which overcomes the foregoing drawbacks and can reduce its manufacturing time and manufacturing costs.

It is another object of the present invention to provide a method of manufacturing a vacuum chamber which can easily be made larger in size than the above conventional method, avoiding outgassing and welding distortion in high or ultra-high vacuum circumstances.

### SUMMARY OF THE INVENTION

According to the first aspect of the present invention there is provided a method of manufacturing a vacuum chamber which comprises a wall portion having an upper and lower edge surface and formed in a tubular shape with an opening at the upper edge surface, a bottom portion integrally connected with the lower edge surface of the wall portion, and a top-cover portion mounted on the upper edge surface of the wall portion and covering the opening of the wall portion, comprising the steps of: preparing first plate material for the wall portion of the vacuum chamber, the first plate material more than twice a height of the wall portion of the vacuum chamber and having first and second side portion of the wall portion of the vacuum chamber, forming the first and second side portions of the first plate material to have first and second joints at the first and second side portions of the first plate material respectively, setting the first plate material to be located according to a configuration of the wall portion of the vacuum chamber, welding the joints adjacent to each other of the first and second joints of the first plate material together by electron beam welding to be joined each other to form a tubular wall, and dividing the tubular wall by cutting the tubular wall into a plurality of tubular wall parts each of which is for the wall potion of the vacuum chamber.

In this method, a plurality of the wall parts can be manufactured at a time by electron beam welding, which reduces manufacturing time, especially with respect to arrangements for setting of the wall parts with jigs to locate them accurately and adjusting the electron beam welding device to focus its beam on joints of the wall parts with accuracy. This reduction of manufacturing time also reduces its manufacturing costs and is suitable for mass production. In addition, this method can easily provide a vacuum chamber, with practically naught of outgassing from material or absorbing gas on its surface, larger than vacuum chamber made by an extrusion process or boring operation.

The first material preferably comprises first and second wall plates respectively having first and second side portion and intermediate portion between the first and second side portions of the first and second wall plates, the first wall plates deeper than the second wall plates, and the first wall plates are formed to have first and second joints at both side portions of the first wall plates and projecting from and at angles with the intermediate portions of the first wall plates, and the second wall plates to have first and second joints in a parallel relationship with the intermediate portions of the second plates. Then one of the first and second joints of the first wall plates and one of the first and second joints of the second wall plates are welded together. This avoids damage to inner surfaces of the first wall plates by electron beam penetrating the joints of the first and second wall plates, which saves manufacturing time to finish the inner surface of the first wall plates by machining operation.

The projecting joints are preferably made by three methods.

The first one is to machine the first wall plates deeper than the second wall plates so that the intermediate portion of the first wall plates are partly cut off to form the first and second joints projecting from and at angles with the intermediate portions of the first wall plates. In this case, it is desirable in view of saving manufacturing time and costs that the first wall plates are narrower than the second plates, which results in the fact that a volume of the cutting off area of the first wall plates to form the first and second joints are smaller than cutting off the first wall plates wider than the second wall plates. This method is superior to the under-mentioned methods because of no need for mold, which saves manufacturing costs and has no restriction on making vacuum chambers larger. Moreover this method does not need for stamping to bend the both side portions of the first wall plates, which easily avoids outgassing from the bending portions.

The second method is to form the first and second joints of the first wall plates by stamping the first wall plates. In this method, the first and second side portions of the first wall plates are deflected in bending, then machined to form the first and second joints projecting from and at angles with the intermediate portions of the first wall plates. This method has the same advantages as the first method with respect to the restriction on making vacuum chambers larger, and saves manufacturing time more than the first method.

The third method is to form the first and second joints of the first wall plates by extrusion molding. In this method, the first and second side portions of the first wall plates are integrally formed at the first and second side portions, projecting from and at angles with the intermediate portions of the first wall plates, then machined the to form the first and second joints projecting from and at angles with the intermediate portions of the first wall plates respectively. It is noted that the first material comprises a plurality of wall plates, for example the above first and second wall plates and then they are welded together to form a tubular wall, which can make a larger vacuum chamber than a integrally molded tubular wall. This method is suitable for mass production because of its rapid speed of forming the first and second side portions of the first wall plates projecting from the intermediate portions of the first wall plates, nothing else that a mold is needed.

The machined inner surface of the vacuum chamber can be obtained before joint welding step if the side portions of the first and second wall plates are the same in deep and the first and second joints of the first wall plates are projected from and at angles with the intermediate portions of the first wall plates, which can save manufacturing time by reducing machining operations for joints and inner surface.

When the first and second side portions of the first and second wall plates is machined to form the first and second joints so that the first and second joints of the first and second wall plates are in the same depth and that the first and second side portions of the first wall plates respectively have projection portion at inner sides of the first and second joints of the first wall plates, the projection portions wider than the first and second joints of the first wall plates, and then the first and second wall plates are welded to join the joints adjacent to each other of the first and second joints of the first and second wall plates, it can avoid a damage to inner surface of the tubular wall by electron beam penetrating the joints of the first and second wall plates, which saves manufacturing time to finish the inner surface of the tubular wall by machining operation. It allows the first and second joints to be short in projecting length, which saves the machining operation of forming the first and second joints of the first wall plates.

Other objects and advantages of the invention will become apparent during the following discussion of the accompanying drawings wherein:

### BRIEF DESCRIPTION OF THE DRAWINGS

The objects, features and advantages of the present invention will become apparent as the description proceeds when taken in conjunction with the accompanying drawings, in which:

FIG. 1 is a perspective view of a vacuum chamber made by the method of manufacturing a vacuum chamber according to the present invention.

FIG. 2 is a perspective view of materials prepared for manufacturing the vacuum chamber in a preparing step.

FIG. 3 is a perspective view of wall plates with joints to be the wall portion of the vacuum chamber formed in a joint forming step.

FIG. 4 is a perspective view of a tubular wall joined together in a welding step.

FIG. 5 is a perspective view of three wall parts divided from the tubular wall in a divided step.

FIG. 6 is a perspective view of the wall part and a bottom part before joining together.

FIG. 7 is a perspective view of the wall part integrally with the bottom part and the third plate material to be the top-cover portion of the vacuum chamber.

FIG. 8 is an enlarged partial cross sectional view of welding zone of the wall part and the bottom part.

FIG. 9 is an enlarged partial cross sectional view of the wall part and the bottom part of a variation of welding zone in FIG. 8.

### DESCRIPTION OF THE PREFERRED EMBODIMENTS

Throughout the following detailed description, similar reference characters and numbers refer to similar elements in all figures of the drawings.

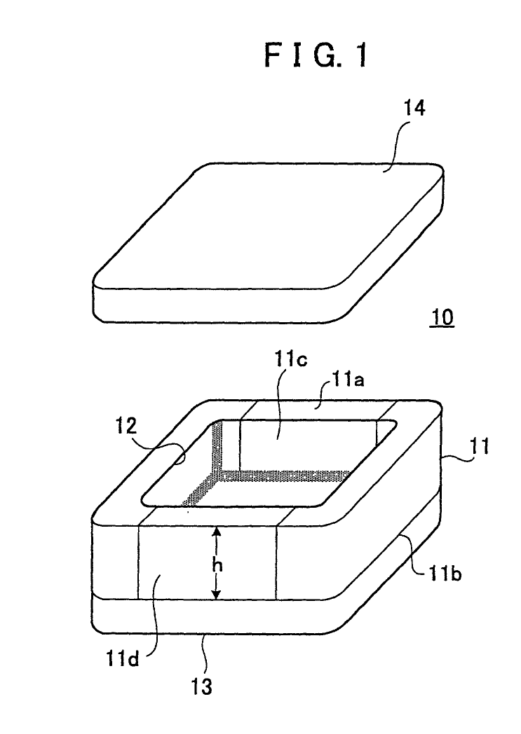

Referring to FIG. 1 of the drawings, there is shown a first preferred embodiment of the vacuum chamber made by the method of manufacturing a vacuum chamber according to the present invention. It is noted that the vacuum chamber 10 shown in FIG. 1 is not a final product which are used in customer's process of manufacturing LCDs and others. To obtain the final product, the vacuum chamber 10 shown in FIG. 1 is machined to have bolt holes, a groove for seal, and openings such as a view port, a feed through outlet, and door way to meet demand of customers. The vacuum chamber 10 comprises a wall portion 11 having an upper and lower edge surface 11a and 11b and formed in a tubular shape having a quadrangle profile and an opening 12 with quadrangle section. The wall portion 11 is integrally connected at the lower edge surface 11b of the wall portion 11 with a bottom portion 13, which covers under portion of the opening 12 of the wall portion 11. The upper portion of the opening 12 of the wall portion 11 is covered by the top-cover portion 14. The top-cover portion 14 is secured to the upper edge surface 11a by bolts, not shown, to be attachable to and detachable from the wall portion 11. The upper edge surface 11a area of the wall portion 11 and the top-cover portion 14 are grooved, not shown, at their contacting faces, and in their grooves a seal is placed and compressed by them to avoid gas leak from gap between the wall portion 11 and the top-cover portion 14.

The above vacuum chamber 10 is manufactured as follows:

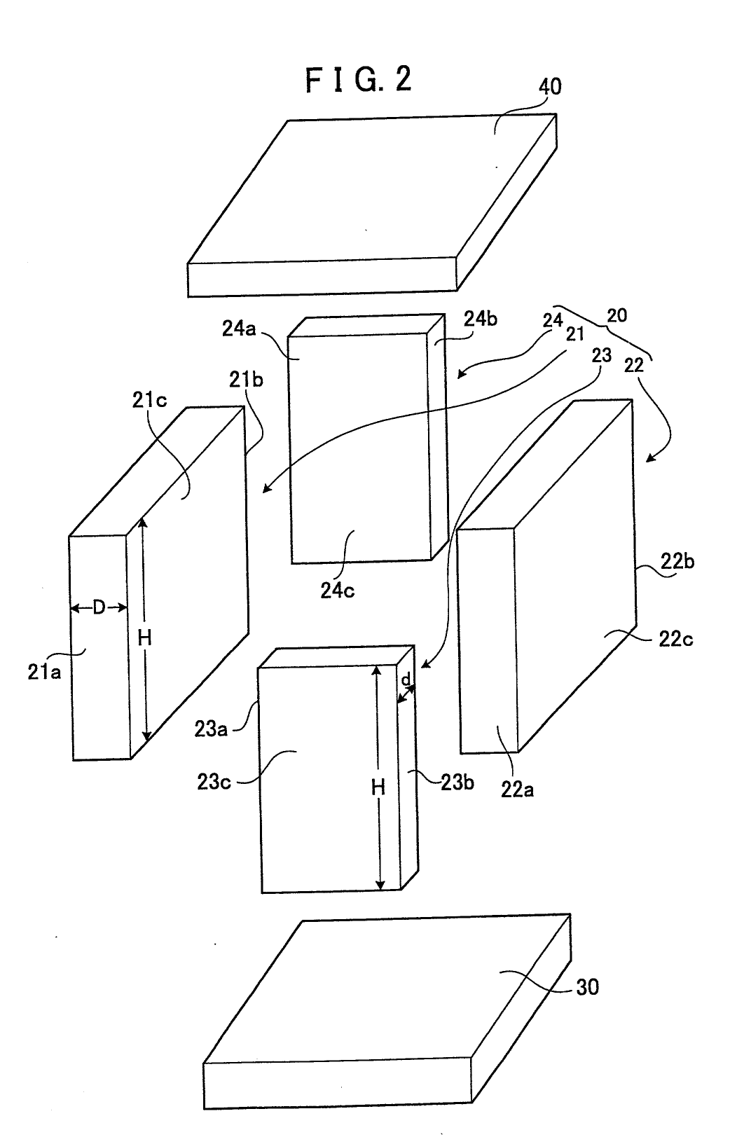

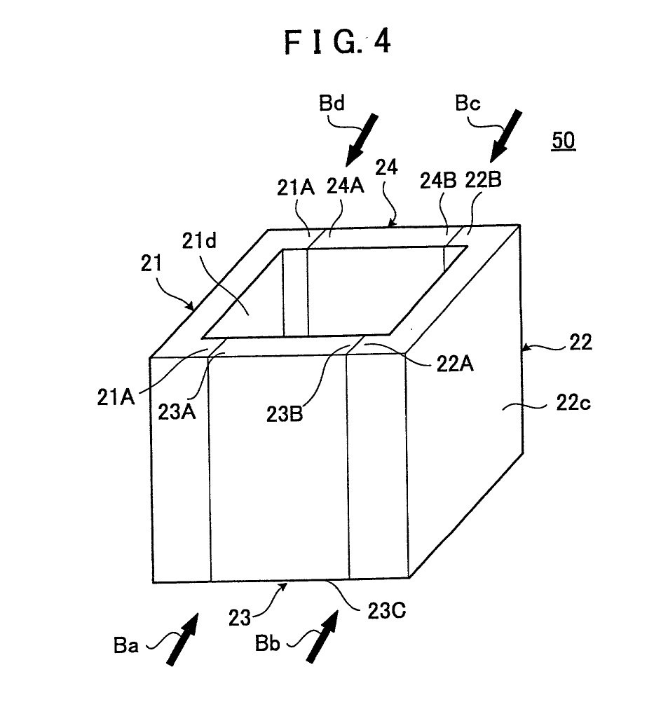

At first, to make the vacuum chamber 10 in FIG. 1, some plate materials are prepared. As shown in FIG. 2, the materials for the preparation comprises a first plate material 20 to be the wall portion 11 of the vacuum chamber 10, a second plate material 30 to be the bottom portion 13 of the vacuum chamber 10, and a third plate material 40 to be the top-cover portion 14 of the vacuum chamber 10. These plate materials 20, 30 and 40 are made of aluminum alloy, such as 5000series- (preferably 5052) or 6000series- wrought aluminum alloy according to the standard of The Alminum Association (AA). The first plate material 20 has a height “H” adding heights of cutting stocks of the tubular wall 50, shown in FIG. 4 and referred later, in a dividing process to three times a height “h” of the wall portion 11 of the vacuum chamber 10. The first plate material 20 comprises first wall plates 21 and 22, and second wall plates 23 and 24, the first wall plates 21 and 22 being deeper and narrower than the second wall plates 23 and 24. The first wall plates 21 and 22 have the same configurations as each other, and the second wall plates have the same configurations as each other. The first wall plates 21 and 22, and the second wall plates 23 and 24 have first and second side portion 21a and 21b, 22a and 22b, 23a and 23b, 24a and 24b, and flat intermediate portion 21c, 22c, 23c, and 24c between the first and second side portions 21a and 21b, 22a and 22b, 23a and 23b, 24a and 24b respectively.

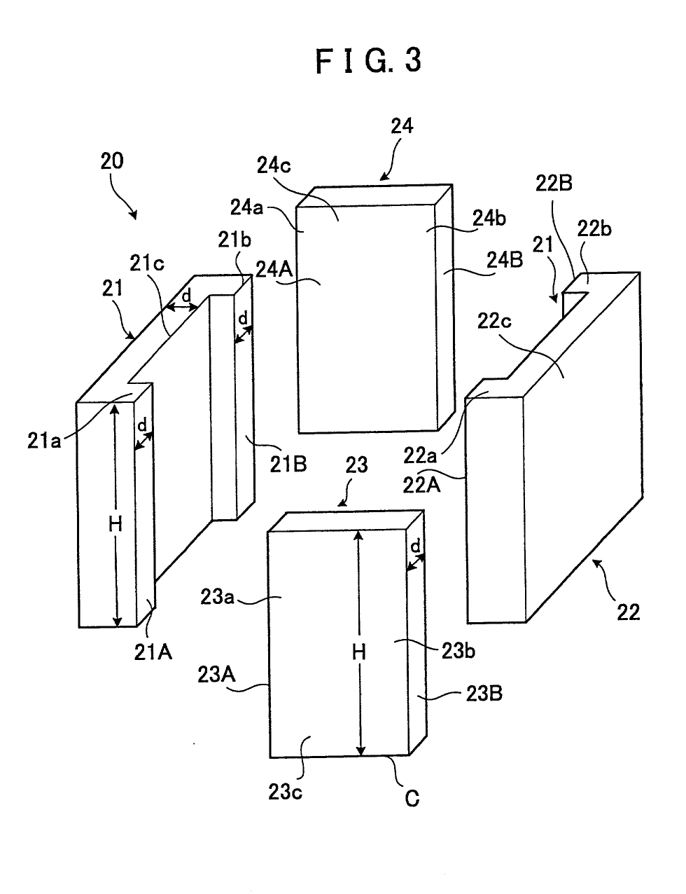

These prepared plate materials 20 and 30 are, as shown in FIG. 3, machined to form their joints for welding as follows:

The first wall plates 21 and 22 are machined to cut off inner surface side area of the intermediate portions 21c and 22c and form first and second joints 21A and 21B, 22A and 22B at the first and second side portions 21a and 21b, 22a and 22b. The first and second joints 21A and 21B, and 22A and 22B of the first wall plates 21 and 22 are respectively projected about 5-10 mm in a perpendicular direction to and from the intermediate portions 21c and 22c, where the first and second joints 21A and 21B, and 22A and 22B of the first wall plates 21 and 22 are symmetrical. The first and second joints 21A and 21B, and 22A and 22B of the first wall plates 21 and 22 have the same depths “d” as the second wall plates 23 and 24. The first and second joints 21A, 21B, 22A, 22B, 23A, 23B, 24A, and 24B of the first and second wall plates 21, and 22, 23 and 24 are respectively grooved at their inner and outer side edges for welding. After forming the above joints, the first and second wall plates 21 and 22, 23 and 24 are cleaned.

The first and second wall plates 21 and 22, 23 and 24 are set, or temporally assembled, to be located in a tubular shape according to a configuration of the wall portion 11 of the vacuum chamber 10. In detail, the first wall plate 21 and 22, and the second wall plate 23 and 24 are located so that the first joints 21A of the first wall plate 21 faces the first joint 23A of the second wall plate 23. The first wall plate 21 and the second wall plate 24 are located so that the second joint 21B of the first wall plate 21 faces the first joint 24A of the second wall plate 24. The first wall plate 22 and the second wall plate 23 are located so that the first joint 22A of the first wall plate 22 faces the second joint 23B of the second wall plate 23. The first wall plate 22 and the second wall plate 24 are located so that the second joint 22B of the first wall plate 22 faces the second joint 24B of the second wall plate 24. Into the located wall plates 21, 22, 23, and 24, jigs, not shown, are incorporated.

The above temporally assembly of the first and second wall plates 21 and 22, 23 and 24 are placed in a evacuated chamber of an electron beam welding device, and setting the location of the temporally assembly, beam focus of the electron beam welding device, and so on in a state practicable for welding. After this setting is finished, the evacuated chamber is vacuumed to high vacuum. The electron beam device, not shown, has an electron beam gun movable in both vertical and horizontal directions, and can focus its dense stream of high -velocity electrons on the joints of the wall plates 21 and 22, 23 and 24. As shown in FIG. 4, the electron beam gun are moved in the vertical direction to focus its electron beam, shown as an arrow “Ba”, on the first joints 21A and 23A of the first and second wall plates 21 and 23 to join them together, then moving in the horizontal direction to the first joint 22A of the first wall plate 22 and the second joint 23B of the second wall plate 23 without focusing the electron beam. The electron beam gun moves in the vertical direction to focus its electron beam, shown as an arrow “Bb”, on the first joint 22A of the first wall plate 22 and the second joint 23B of the second wall plate 23 to join them together. Then the temporally assembly is turned around 180 degrees, and the electron beam gun moves to focus its beam on the second joint 21B of the first wall plate 21 and the second joint 24A of the second wall plate 24. The second joint 21B of the first wall plate 21 and the second joint 24A of the second wall plate 24 are joined together by electron beam, shown as an arrow “Bd”, moving in the vertical direction. The electron beam gun moves in the horizontal direction to the second joint 22B of the first wall plate 22 and the second joint 24B of the second wall plate 24 without focusing the electron beam, then moving in the vertical direction to focus its beam, shown as an arrow “Bc”, on the second joint 22B of the first wall plate 22 and the second joint 24B of the second wall plate 24 to join them together. Therefore, this welding operation makes the first and second wall plates 21 and 22, 23 and 24 are joined together to form a tubular wall 50.

After this welding operation, the jigs are detached from the tubular wall 50, weld spatter on the tubular wall 50 being removed, and the tubular wall 50 cleaned.

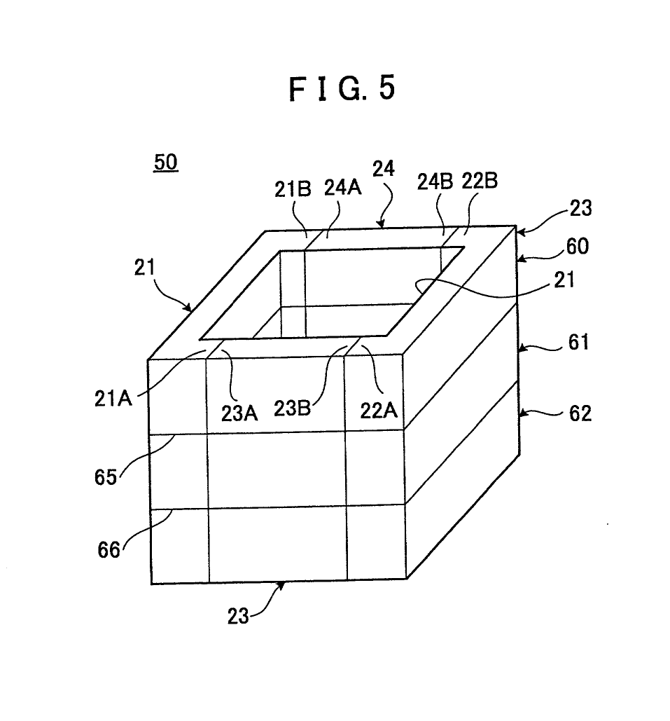

The tubular wall 50 is brought out from the evacuated chamber, and, as shown in FIG. 5, divided by cutting operation along cutting lines 65 and 66 into three pieces of wall parts 60, 61, and 62 of the same height “h” as the wall portion 11 of the vacuum chamber 10. The wall part 60 is machined at their under edge portion 60b to form a third joint 60C, and the wall parts 61 and 62 are also machined to form third joints respectively. After this machining operation, these wall parts 60, 61, and 62 are cleaned.

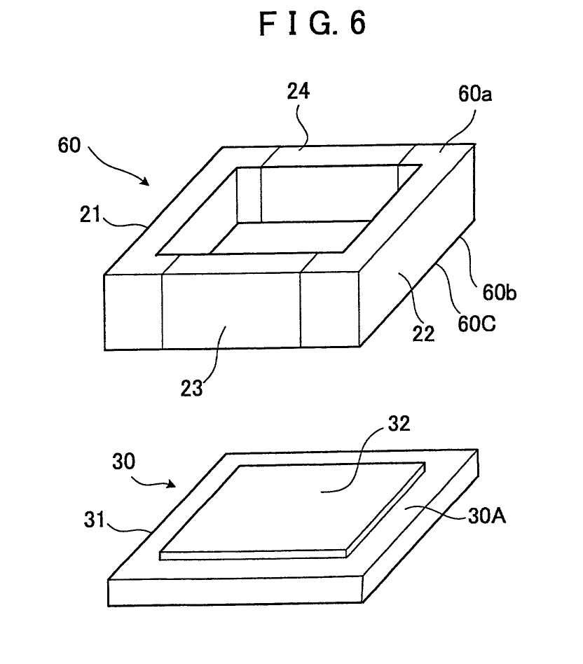

Collaterally to making the wall parts 60, 61, and 62, the second plate material 30 is, as shown in FIG. 6, machined to cut off an upper periphery portion of the second plate material 30, forming a bottom part 31 with a first joint 30A surrounding a square projection 32. In this process, three bottom parts 31 are prepared according to a number of the wall parts 60, 61, and 62.

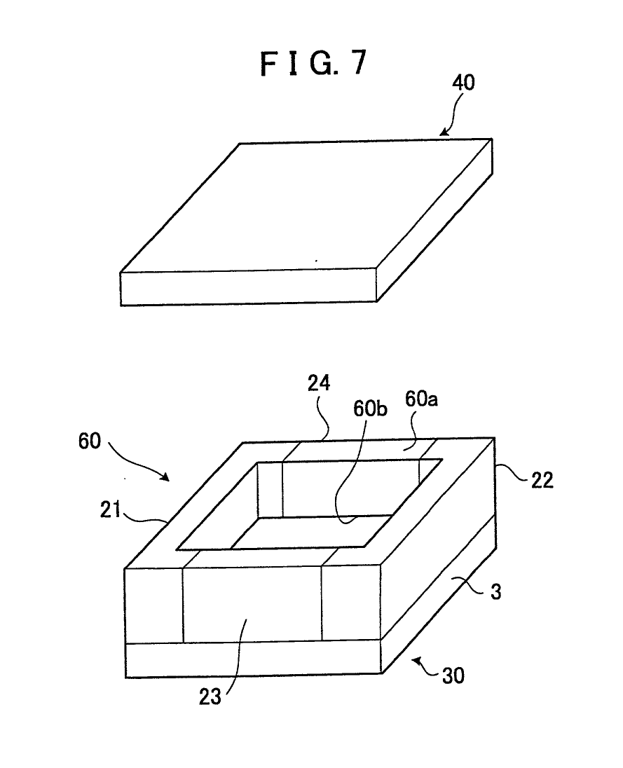

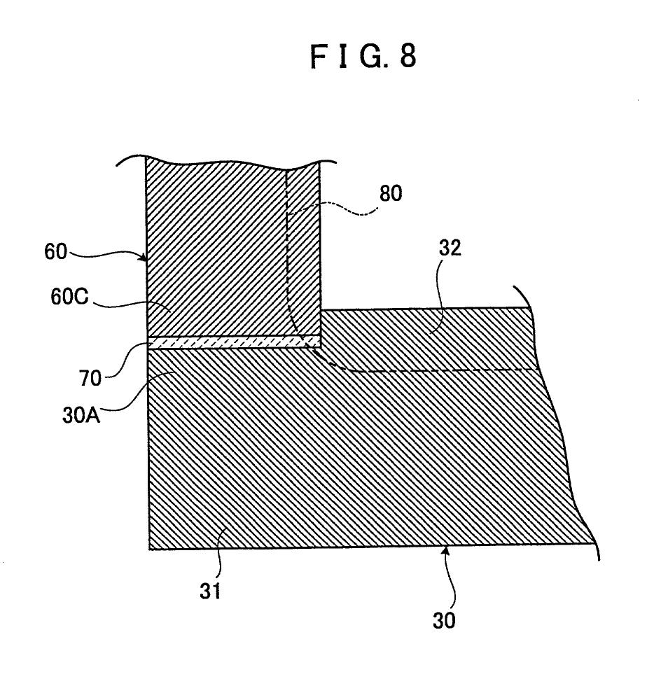

One 60 of the wall parts 60, 61, and 62 and the bottom part 31 are placed with jigs in the evacuated chamber, and welded by electron beam welding at the third joint 60C of the wall part 60 and the first joint 30A of the bottom part 31 to join them together as seen in FIG. 7. FIG. 8 shows an enlarged partial cross sectional view of a welded portion 70 of the third joint 60C of the wall part 60 and the first joint 30A of the bottom part 31. The welded portion 70 by electron beam is restricted at the side portion of the projection 32, which avoids spatter on the inner surface of projection 32 of the bottom part 31.

Then the wall part 60 integrally with bottom part 31 is machined to form inner surface along dashed line 80, which forms curved surface at corner where the wall part 60 and bottom part 31 encounter. It is noted that the inner surface along the dashed line 80 is positioned between both edges of the welding portion 70 so as to avoid a gap between the under portion of the wall part 60 and a side portion of the projection 32 of the base part 31. This prevents the wall part 60 integrally with bottom part 31 from out gassing. The wall part 60 is also machined to form curved surfaces at side comers of the first and second wall plates 21 and 22, 23 and 24.

An upper edge portion 60a of the wall part 60 integrally with bottom part 31 is covered by the third plate material 40 to be the top-cover portion 14 of the vacuum chamber 10. The third plate material 40 is secured to the wall part 60 by bolts to be attachable to and detachable from the wall part 60.

In this manufacturing method, as three pieces of wall parts are manufactured by electron beam welding in one welding step, it does not need to repeat the arrangements for electron beam welding which takes a very long time. This results in that this method reduces manufacturing time and manufacturing costs, which is suitable for of mass production of vacuum chambers. In addition, this method can provide a vacuum chamber suitable for manufacturing larger vacuum chamber with practically naught of outgassing from material or absorbing gas on its surface. Moreover as the first wall plates 21 and 22 are narrower than other wall plates, machining operation to form the first and second joints 21A and 21B, 22A and 22B can reduce its manufacturing time and costs.

The invention may be embodied in other specific forms without departing from the spirit or essential characteristics thereof. The present embodiment is therefore to be considered in all respects as illustrative and not restrictive, the scope of the invention being indicated by the appended claims rather than by the fore going description and all changes which come within the meaning and range of equivalency of the claims are therefore intended to be embraced therein.

For example, although the first and second side portion 21a and 21b, 22a and 22b of the first and second wall plates 21 and 22 are formed by machining operation in the above embodiment, there are other operations to form them. One of the operations is stamping the first wall plates 21 and 22 so that the first and second side portions 21a and 21b, 22a and 22b of the first wall plates 21 and 22 are deflected in bending, then machining the first and second side portions 21a and 21b, 22a and 22b of the first wall plates 21 and 22 to form the first and second joints 21A and 21B, and 22A and 22B projecting from and at angles with the intermediate portions 21c and 22c of the first wall plates 21 and 22, and machining the first and second side portions 23a and 23b, 24a and 24b of the second wall plates 23 and 24 so that the first and second joints 23A and 23B, 24A and 24B of the second wall plates 23 and 24 are in a parallel relationship with the intermediate portions 23c and 24c of the second plates 23 and 24.

Another one is forming the first wall plates 21 and 22 by extrusion molding so that the first and second side portions 21a and 21b, 22a and 22b of the first wall plates 21 and 22 have integrally the first and second side portions 21a and 21b, 22a and 22b projecting from and at angles with the intermediate portions 21c and 22c of the first wall plates 21 and 22, then machining the first and second side portions 21a and 21b, 22a and 22b of the first wall plates 21 and 22 to form the first and second joints 21A and 21B, 22A and 22B projecting from and at angles with the intermediate portions 21c and 22c of the first wall plates 21 and 22 respectively, and machining the first and second side portions 23a and 23b, 24a and 24b of the second wall plates 23 and 24 so that the first and second joints 23A and 23B, 24A and 24B of the second wall plates 23 and 24 are in a parallel relationship with the intermediate portions 23c and 24c of the second plates 23 and 24. In these embodiments, to form joints projecting from the intermediate portion of the wall plates, the first wall plates 21 and 22 and the second wall plates 23 and 24 can be replaced.

The height “H” of the first plate material 20 of the above embodiment is tree times the height “h” of the wall portion 11 of the vacuum chamber 10, which in not restricted. The height “H” of the first plate material 20 may be determined to be more than twice the height “h” of the wall portion 11 of the vacuum chamber 10, for example five or six times.

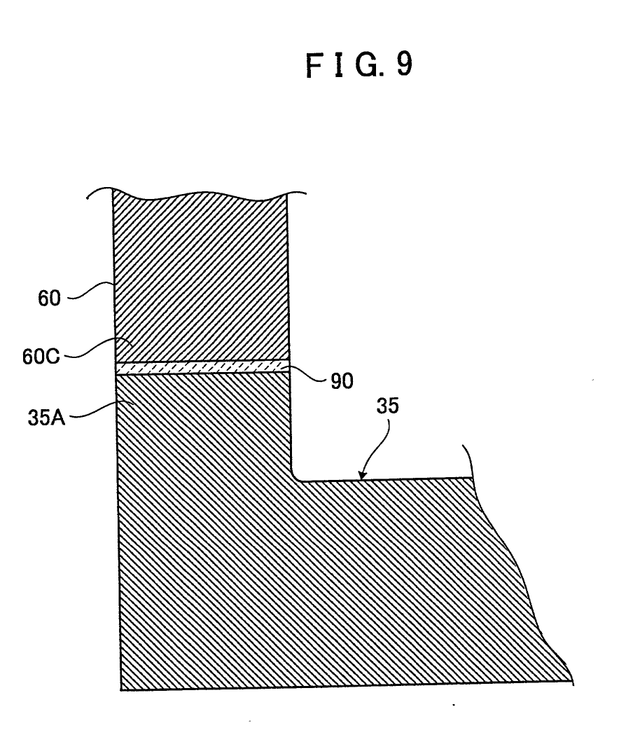

The first plate material may be one wall plate, or several kinds of wall plates. When the first plate material is one wall plate, this wall plate is formed in a tubular shape, for example, by stamping, and machined at its both side portions to have a first and second joints. When there are several kinds of wall plates including the first and second wall plates, the first wall plate and the second wall plate are connected with each other at first joint of the first wall plate and the first joint of the second wall plates respectively, the second joint of the first wall plate and another first joint of another second plate connected with each other, the second wall plates are connected at the second side portion of the second wall plates with another kind of wall plates, and so on to form polygonal vacuum chamber. The first and second joints of the first and second wall plates may be formed to have joints with inner projection, like the bottom part 31 has in FIG. 8. The bottom part 31 can be replaced a bottom part 35 shown in FIG. 9, in this case the second plate material 30 is formed into a bottom part 35 which has a first joint 35A projected in a perpendicular direction to the bottom part 35 at an upper periphery portion of the bottom part 35. The wall part 60 and the bottom part 35 are welded at the third joint 60C of the wall part 60 and the first joint 35A of the bottom part 35 to be joined together. In this embodiment, machining operation can be made at a time for forming the inner surfaces of the vacuum chamber and forming the first and second joints in a joint forming step before a temporally assembling step. The machined inner surfaces of the temporally assembly is covered by spatter protecting sheet in a welding step so that the inner surfaces are kept clean from spatter. It therefore reduces machining time and costs.

The present disclosure relates to subject matters in Japanese Patent Applications No. 2001-169259 filed on Jun. 5, 2001, which is expressly incorporated herein by reference in its entirety.

What is claimed is:

1. A method of manufacturing a vacuum chamber which comprises a wall portion having upper and lower edge surface and formed in a tubular shape with an opening at the upper edge surface, a bottom portion integrally connected with the lower edge surface of the wall portion, and a top-cover portion mounted on the upper edge surface of the wall portion and covering the opening of the wall portion, comprising the steps of:
(a) preparing first plate material for the wall portion of the vacuum chamber, the first plate material more than twice a height of the wall portion of the vacuum chamber and having first and second side portion of the wall portion of the vacuum chamber,
(b) forming the first and second side portions of the first plate material to have first and second joint at the first and second side portions of the first plate material respectively,
(c) setting the first plate material to be located according to a configuration of the wall portion of the vacuum chamber,
(d) welding the joints adjacent to each other of the first and second joints of the first plate material together by electron beam welding to be joined each other to form a tubular wall, and
(e) dividing the tubular wall by cutting the tubular wall into a plurality of tubular wall parts each of which is for the wall potion of the vacuum chamber.

2. A method of manufacturing a vacuum chamber as set forth in claim 1, wherein the first plate material has a height adding a height of cutting stocks of the tubular wall in the dividing step to a integer multiple of the height of the wall portion of the vacuum chamber.

3. A method of manufacturing a vacuum chamber as set forth in claim 1, wherein the first plate material is one of aluminum, aluminum alloy, and stainless steel.

4. A method of manufacturing a vacuum chamber as set forth in claim 1,
wherein the preparing step includes preparing the first plate material which comprises first and second wall plates respectively having first and second side portion and intermediate portion between the first and second side portions of the first and second wall plates, the first wall plates deeper than the second wall plates, and
wherein the joint forming step includes machining the first wall plates so that the intermediate portion of the first wall plates are partly cut off to form the first and second joints projecting from and at angles with the intermediate portions of the first wall plates, and machining the second wall plates so that the first and second joints of the second wall plates are in a parallel relationship with the intermediate portions of the second plates.

5. A method of manufacturing a vacuum chamber as set forth in claim 4, wherein the first wall plates are narrower than the second wall plates.

6. A method of manufacturing a vacuum chamber as set forth in claim 1,
wherein the preparing step includes preparing the first plate material which comprises first and second wall plates respectively having first and second side portion and intermediate portion between the first and second side portions of the first and second wall plates, the first and second wall plates equal in depth to each other, the first wall plates narrower than the second wall plates, and
wherein the first joint forming step includes stamping the first wall plates so that the first and second side portions of the first wall plates are deflected in bending, machining the first and second side portions of the first wall plates to form the first and second joints projecting from and at angles with the intermediate portions of the first wall plates, and machining the first and second side portions of the second wall plates so that the first and second joints of the second wall plates are in a parallel relationship with the intermediate portions of the second plates.

7. A method of manufacturing a vacuum chamber as set forth in claim 1,
wherein the preparing step includes preparing the first plate material which comprises first and second wall plates respectively having first and second side portion and intermediate portion between the first and second side portions of the first and second wall plates, the first and second wall plates equal in depth to each other, the first wall plates narrower than the second wall plates, and
wherein the joint forming step includes forming the first wall plates by extrusion molding so that the first and second side portions of the first wall plates have integrally the first and second side portions projecting from and at angles with the intermediate portions of the first wall plates, machining the first and second side portions of the first wall plates to form the first and second joints projecting from and at angles with the intermediate portions of the first wall plates respectively, and machining the first and second side portions of the second wall plates so that the first and second joints of the second wall plates are in a parallel relationship with the intermediate portions of the second plates.

8. A method of manufacturing a vacuum chamber as set forth in claim 1,
wherein the preparing step includes preparing the first plate material which comprises first and second wall plates respectively having first and second side portion and intermediate portion between the first and second side portions of the first and second wall plates, the first and second wall plates equal in depth to each other, the first wall plates narrower than the second wall plates, and
wherein the joint forming step includes stamping the first wall plates so that the first and second side portions of the first wall plates are deflected in bending, machining the first and second side portions of the first wall plates to form the first and second joints projecting from and at angles with the intermediate portions of the first wall plates, and machining the first and second side portions of the second wall plates so that the first and second joints of the second wall plates are in a parallel relationship with the intermediate portions of the second plates.

9. A method of manufacturing a vacuum chamber as set forth in claim 1,
wherein the preparing step includes preparing the first plate material which comprises first and second wall plates respectively having first and second side portion and intermediate portion between the first and second side portion of the first and second wall plates, the first and second wall plates equal in depth to each other, the first wall plates narrower than the second wall plates, and
wherein the joint forming step includes stamping the second wall plates so that the first and second side portions of the second wall plates are deflected in bending, machining the first and second side portions of the second wall plates to form the first and second joints projecting from and at angles with the intermediate portions of the second wall plates, and machining the first and second side portions of the first wall plates so that the first and second joints of the first wall plates are in a parallel relationship with the intermediate portions of the first plates.

10. A method of manufacturing a vacuum chamber as set forth in claim 1,
wherein the preparing step includes preparing the first plate material which comprises first and second wall plates respectively having first and second side portion and intermediate portion between the first and second side portions of the first and second wall plates, the first and second wall plates equal in depth to each other, the first wall plates narrower than the second wall plates, and
wherein the joint forming step includes forming the first wall plates by extrusion molding so that the first and second side portions of the first wall plates have integrally the first and second side portions projecting from and at angles with the intermediate portions of the first wall plates, machining the first and second side portions of the first wall plates to form the first and second joints projecting from and at angles with the intermediate portions of the first wall plates respectively, and machining the first and second side portions of the second wall plates so that the first and second joints of the second wall plates are in a parallel relationship with the intermediate portions of the second plates.

11. A method of manufacturing a vacuum chamber as set forth in claim 1,
wherein the preparing step includes preparing the first plate material which comprises first and second wall plates respectively having first and second side portion and intermediate portion between the first and second side portions of the first and second wall plates, the first and second wall plates equal in depth to each other, the first wall plates narrower than the second wall plates, and
wherein the joint forming step includes forming the second wall plates by extrusion molding so that the first and second side portions of the second wall plates have integrally the first and second side portions projecting from and at angles with the intermediate portions of the second wall plates, machining the first and second side portions of the second wall plates to form the first and second joints projecting from and at angles with the intermediate portions of the second wall plates respectively, and machining the first and second side portions of the first wall plates so that the first and second joints of the first wall plates are in a parallel relationship with the intermediate portions of the first plates.

12. A method of manufacturing a vacuum chamber as set forth in claim 1,
wherein the preparing step includes preparing the first plate material which comprises first and second wall plates respectively having first and second side portion and intermediate portion between the first and second side portions of the first and second wall plates, the first and second wall plates equal in depth to each other, and
wherein the joint forming step includes machining the first and second side portions of the first and second wall plates to form the first and second joints so that the first and second joints of the first and second wall plates are in the same depth, and machining inner surfaces of the first and second wall plates.

13. A method of manufacturing a vacuum chamber as set forth in claim 1,
wherein the preparing step includes preparing the first plate material which comprises first and second wall plates respectively having first and second side portion and intermediate portion between the first and second side portions of the first and second wall plates, the first wall plates deeper than the second wall plates,
wherein the joint forming step includes machining the first and second side portions of the first and second wall plates to form the first and second joints so that the first and second joints of the first and second wall plates are in the same depth and that the first and second side portions of the first wall plates respectively have projection portion at inner sides of the first and second joints of the first wall plates, the projection portions wider than the first and second joints of the first wall plates, and
wherein the welding step includes welding the first and second wall plates to join the joints adjacent to each other of the first and second joints of the first and second wall plates.

14. A method of manufacturing a vacuum chamber as set forth in claim 13, which further comprises the step of cutting off the projection portions and inner surface portions of the first wall plates after the welding step.

15. A method of manufacturing a vacuum chamber as set forth in claim 1,
wherein the preparing step includes a second plate material for the bottom portion of the vacuum chamber and a third plate material for the top-cover portion of the vacuum chamber, and
which further comprises the step of welding the wall part and the second plate material to be joined together and securing the third plate material to the wall part.

16. A method of manufacturing a vacuum chamber as set forth in claim 15, which further comprises the step of forming a third joint at an under edge portion of the wall part, and forming the second plate material to have a first joint at an upper periphery portion of the second plate material, and a projection surrounded by the first joint of the second plate material, and
wherein the wall part welding step of welding the third joint of the wall part and the first joint of the second plate material.

17. A method of manufacturing a vacuum chamber as set forth in claim 15, which further comprises the step of cutting off the projection and inner surface portion of the second plate material after the wall part welding step.

18. A method of manufacturing a vacuum chamber as set forth in claim 15, which further comprises the step of forming a third joint at an under edge portion of the wall part, and forming the second plate material to have a first joint at an upper periphery portion of the second plate material, the first joint of the second plate material and the third joint of the wall part equal in depth to each other, and machining inner surfaces of the wall part and the second plate material, and
wherein the wall part welding step of welding the third joint of the wall part and the first joint of the second plate material.

19. A tubular wall made by the method of claim 1.

20. A wall part made by the method of claim 1.
